(19) United States
(12) Patent Application Publication
(10) Pub. No.: US 2025/0329479 A1
(43) Pub. Date: Oct. 23, 2025

(54) METHODS AND APPARATUS FOR COPPER NICKEL-IRON HYBRID MATERIALS

(71) Applicant: Atlas Magnetics, Reno, NV (US)

(72) Inventor: John Othniel McDonald, Reno, NV (US)

(21) Appl. No.: 19/256,021

(22) Filed: Jun. 30, 2025

Related U.S. Application Data
(63) Continuation-in-part of application No. 18/135,660, filed on Apr. 17, 2023.
(63) Continuation-in-part of application No. 18/131,350, filed on Apr. 5, 2023.
(60) Provisional application No. 63/666,017, filed on Jun. 28, 2024.

(51) Int. Cl. H01B 7/30; H01F 1/14

(52) U.S. Cl. CPC H01B 7/30; H01F 1/14

(57) ABSTRACT

The present invention relates to methods and apparatus for creating hybrid conductive materials that are highly resilient to the skin effect across a wide range of frequencies. The present disclosure provides a hybrid conductive material comprising a conductive layer, a magnetic alloy layer operably connected to the conductive layer, and a hybrid insulation layer operably connected to at least one of the conductive layer or the magnetic alloy layer. For example, the conductive layer may comprise copper, the magnetic alloy layer may comprise a nickel-iron alloy selected from 80:20, 36:64, and 40:60 nickel to iron ratios, and the hybrid insulation layer may comprise a particulate-based insulation material.

### FIELD OF INVENTION

The present invention relates to the field of thin film conductive material and material science. Without limiting the indication, the present invention is directed toward novel hybrid conductive materials infused with diamagnetic materials and the methods of producing, as well as using, such hybrid materials.

### BACKGROUND

It is well known that as the frequency of an alternating current increases, the current density at the surface of the conductor will increase while the current density will decrease towards the center. This produces what is known as the skin effect. It occurs because the alternating current generates magnetic flux with each alternation, and the flux produces eddy currents that oppose the original current, driving the current toward the surface of the conductor.

To reduce the impact of the skin effect, typically a laminated or otherwise insulated conductor, for example, a litz wire, will be used. The laminations or insulation in these wires increase the conductor's surface area by delineating a portion of the conductor while also serving as insulation that helps prevent the formation of eddy currents.

However, making Litz wires or other high-frequency capable wires requires a multi-step process that is time-consuming and costly compared to a simple bulk material wire. The same is true for laminated conductive components in general, as the multiple steps involved in laminating the conductor with insulation layers increase the time and cost it takes to make the conductive component.

However, as the frequency of the current increases, the eddy currents become smaller, stronger, and more localized, requiring tighter and tighter laminations to combat them. This makes designing conductors for higher frequencies a challenge.

In 2020, researchers Y. Aizawa, H. Nakayama, K. Kubomura, R. Nakamura, and H. Tanaka proposed a novel method of increasing skin depth in conductors by focusing on repressing the magnetic flux generated by the current. To do this, they used magnetic alloy layers, typically considered a magnetically permeable material, as laminations in a copper-based conductor.

The genius of these researchers was to realize that at high enough frequencies, nickel-iron “permalloy” and similar alloys' permeability drops below zero, resulting in magnetic flux that is being generated by current flow through the permalloy being expelled from the material. By dropping below zero, the nickel-iron becomes what is known as diamagnetic, a tendency to reduce or expel a magnetic field.

By laminating layers of copper with nickel-iron, they were able to create layers with more isolated magnetic fields between layers. The magnetic flux is suppressed between the metallic layers at high frequencies, resulting in less eddy current generation, which increases the skin depth of the metamaterial conductor, i.e., the layered copper and NiFe.

The downside to nickel-iron laminations is that they are more magnetically permeable than copper at low frequencies, so they allow more magnetic flux to be generated. This actually reduces the skin depth of wires or traces the nickel-iron is incorporated at lower frequencies. Yet, this material remains improved with lower AC resistance for the highest-frequency applications.

As nickel-iron's magnetic properties become diamagnetic at high frequency and does not require a significant increase in manufacturing steps or cost, it would be beneficial to the industry to extend the frequency range that a copper nickel-iron conductor has a large skin depth in while preserving the size, affordability, and ease of manufacturing the copper nickel-iron conductor. Further, although NiFe performs well at high frequency, in the competitive electronics industry, it is always worth pushing performance further.

As the demand for high-frequency applications continues to grow, there is an ongoing need for conductive materials that can maintain low losses and high performance across a broad frequency spectrum. The ability to control and manipulate the behavior of electromagnetic fields within a conductor remains an active area of research and development in the field of material science.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a hybrid conductive material is provided. The hybrid conductive material includes a conductive layer, a magnetic layer that turns diamagnetic at high frequency for example nickel-iron, nickel-iron-cobalt or any associated alloy of these three fundamental magnetic metals (Co, Ni, Fe) operably connected to the conductive layer, and a hybrid insulation layer operably connected to or interspersed within at least one of the conductive layer or the magnetic layer or heterogeneously co-deposited with the magnetic layer.

According to other aspects of the present disclosure, the hybrid conductive material may include one or more of the following features. The conductive layer in some cases comprises copper for cost reasons or silver for performance. The magnetic layer may comprise a magnetic alloy. Traditional magnetic alloys of iron and nickel have optimal ratios of 80:20, 36:64, and 40:60 whose selection depends on the desired alloy properties. Other alloys may include nickel-iron-cobalt alloys. The hybrid insulation layers may comprise a particulate-based insulation material that is deposited separately or co-deposited with the magnetic layer or both the magnetic and conductive layers. The hybrid conductive material may further comprise an additional conductive layer operably connected to the hybrid insulation layer. The magnetic layer may be positioned between the conductive layer and the hybrid insulation layer, and the hybrid insulation layer may be positioned between the magnetic alloy layer and the additional conductive layer. Multiple hybrid insulation layers may be deposited. In some cases, a hybrid conductive layer, a hybrid magnetic material, or both may be used.

According to another aspect of the present disclosure, a method of forming a hybrid conductive material is provided. The method includes preparing an initial conductive layer, forming a first layer of either hybrid insulation or magnetic alloy layer on a surface of the initial conductive layer, forming a second layer of either hybrid insulation or magnetic alloy, whichever material differs from the first layer, on a surface of the first layer, and depositing an additional conductive layer on a surface of the second layer.

According to other aspects of the present disclosure, the method may include one or more of the following features. In an exemplary embodiment of the present invention, the initial conductive layer may comprise copper or silver and may include a hybrid conductive material. The magnetic alloy layer may comprise a nickel-iron alloy selected from the group consisting of 80:20, 36:64, and 40:60 nickel to iron ratios or a nickel-iron-cobalt alloy and may include a hybrid magnetic material. The hybrid insulation layer may comprise a particulate-based insulation material. The method may further comprise repeating the steps of forming the first layer, forming the second layer, and depositing the additional conductive layer to create a multi-layer stack. The multi-layer stack may comprise at least 1000 layers. By providing more than one insulation layer or by providing hybrid materials, the overall number of layers may remain high, but the total layers of magnetic material and conductive material may remain low. In some cases, in each, or at least one, hybrid insulation layer, the magnetic alloy layer may fill voids in the hybrid insulation layer. In some cases, the magnetic material will not extend more than 1 nanometer above the surface of the hybrid insulation layer. These caveats may create a stack of conducive hybrid layers with thin hybrid magnetic alloy layers.

According to another aspect of the present disclosure, a layered conductive structure is provided. The layered conductive structure includes a first conductive layer, a hybrid insulation layer operably connected to the first conductive layer, a magnetic alloy layer operably connected to the hybrid insulation layer, and a second conductive layer operably connected to the magnetic alloy layer, wherein the magnetic alloy layer becomes diamagnetic at frequencies above 1 GHz.

According to other aspects of the present disclosure, the layered conductive structure may include one or more of the following features. The magnetic alloy layer may comprise a nickel-iron alloy selected from the group consisting of 80:20, 36:64, and 40:60 nickel to iron ratios. The hybrid insulation layer may comprise a particulate-based insulation material. The magnetic alloy layer may fill voids in the particulate-based insulation material of the hybrid insulation layer. The magnetic alloy layer may not extend more than 1 nanometer above a surface of the hybrid insulation layer. The layered conductive structure may further comprise a cobalt-magnetic alloy layer operably connected between the hybrid insulation layer and the magnetic alloy layer.

It is worth noting that in an alternate embodiment, the layer stack may be in any order. Thus, it can simply be said that in an exemplary embodiment, the hybrid material has at least one layer of copper; at least one layer of nickel-iron; and at least one layer of hybrid insulation, all operably bonded or embedded in the form of a layer stack. In certain embodiments, the layers of this stack may be repeated multiple times-even thousands of times.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates the generation of eddy currents in a conductor carrying alternating current, according to aspects of the present disclosure.

FIG. 2 illustrates the behavior of an alternating current and its associated magnetic effects in an exemplary embodiment of the invention.

FIG. 3a shows two ferromagnetic materials and their associated magnetic flux, according to an embodiment.

FIG. 3b shows the interaction between two ferromagnetic materials and their magnetic flux, according to aspects of the present disclosure.

FIG. 4a depicts magnetic flux patterns generated by ferromagnetic and diamagnetic materials when separated, according to an embodiment.

FIG. 4b shows the interaction between ferromagnetic and diamagnetic magnetic flux fields, according to aspects of the present disclosure.

FIG. 4c shows magnetic field interactions between ferromagnetic and diamagnetic materials, according to an embodiment.

FIG. 4d illustrates a theoretically impossible magnetic flux loop configuration, according to aspects of the present disclosure.

FIG. 5 shows a layer stack comprising multiple layers arranged in a stacked configuration, according to an embodiment.

FIG. 6 depicts a graph showing the relationship between permeability and frequency for NiFe material, according to aspects of the present disclosure.

FIG. 7 shows an orthogonal view of an initial conductive layer, according to an embodiment.

FIG. 8 illustrates an orthogonal view of a layer stack comprising two distinct layers, according to aspects of the present disclosure.

FIG. 9 illustrates an orthogonal view of a layered material structure, according to an embodiment.

FIG. 10 illustrates a cross-sectional view of a layered material stack, according to aspects of the present disclosure.

FIG. 11 illustrates an orthogonal view of a layer stack showing two distinct layers, according to an embodiment.

FIG. 12 illustrates an orthogonal view of a layered structure comprising three distinct layers, according to aspects of the present disclosure.

FIG. 13 shows a layered structure comprising multiple distinct layers arranged in a stacked configuration, according to an embodiment.

FIG. 14 illustrates a cross-sectional view of a layered material stack, according to aspects of the present disclosure.

FIG. 15 illustrates a cross-sectional view of a layer stack showing the arrangement of conductive and insulating layers, according to an embodiment.

FIG. 16 illustrates a cross-sectional view of a layered material structure, according to aspects of the present disclosure.

FIG. 17 illustrates a cross-sectional view of a layered material structure, according to an embodiment.

FIG. 18 illustrates a cross-sectional view of a layered material structure, according to aspects of the present disclosure.

FIG. 19 illustrates a layer stack structure comprising multiple alternating layers, according to an embodiment.

FIG. 20 illustrates a layer stack structure comprising multiple alternating layers, according to aspects of the present disclosure.

FIG. 21 illustrates a layer stack pattern comprising multiple conductive and insulating layers, according to an embodiment.

### DETAILED DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

The present invention relates to the field of thin-film conductive materials and materials science. Without limiting the indication, the present invention is directed toward novel hybrid conductive materials infused with diamagnetic materials, as well as the methods of producing such hybrid materials.

The methods of the present invention yield components that can maintain a deep skin depth over both low- and high-frequency alternating currents. On a broad level, the material of the present invention increases skin depth by impeding eddy currents at all frequency ranges and reducing magnetic flux generation at high frequencies. To reduce eddy currents, a hybrid insulation layer is employed, and to minimize magnetic flux at high frequencies, magnetic alloys may be utilized in conjunction with hybrid insulation layers or on their own. For the purposes of the present invention, any alloy that is diamagnetic at high frequencies may be used, for example, alloys of nickel-iron become diamagnetic at high frequencies (over 1 GHz) and as a result alloys of 80:20, 36:64, or 40:60 nickel to iron, which are most commonly available, may be the most commonly used.

Although magnetic at lower frequencies, magnetic alloys, such as permalloys, become diamagnetic when an extremely high-frequency alternating current is applied, typically over 1 GHz. As will be shown below, once diamagnetic, the magnetic flux generated by the magnetic alloy will flow in the opposite direction it flowed as a magnetic ferromagnetic material. This causes the magnetic flux generated by the conductive layer and the diamagnetic layer to oppose each other, and thus the total magnetic flux in the layer stack is reduced.

The hybrid insulation layers can provide sufficient insulation for low and even high-frequency applications. Hybrid insulation can even effectively expand the skin depth to the center of the material across many frequencies commonly used today. Yet, even with hybrid insulation, as the frequency rises into the ultra-high frequency ranges, the skin depth will decrease. However, by utilizing magnetic alloys for example NiFe, almost as a sort of insulating layering, the magnetic flux is reduced at ultra-high frequencies, in turn reducing the strength of the eddy current that the hybrid insulation has to protect against.

It is worth examining how these layers will work together to increase the skin depth of a material. It will be appreciated that skin depth is generally considered to be caused by eddy currents and that a primary driver of these eddy currents is magnetic flux generated by alternating currents. These two causes allow for a two-pronged approach to reduce the skin effect: 1) reduce magnetic fields and 2) reduce eddy current generation.

The present invention presents a layered material that reduces eddy currents and reduces the magnetic flux generated. This material performs well at high frequencies and maintains high performance at low frequencies. Hybrid insulation can significantly reduce eddy currents at both high and low frequencies. The opposing magnetic fields of the magnetic alloy layers reduce the magnetic flux at frequencies above 1 GHz, up to around 20 GHz, for example, in the case of nickel-iron alloys, resulting in weaker eddy currents at high frequencies. It is worth noting that the maximum diamagnetic effect seems to occur at around 1 to 5 GHz with nickel-iron alloys.

It is worth exploring hybrid materials in general; as such, it is worth noting that a hybrid material is best pictured as a single, solid piece of metal built up one ultra-thin layer at a time interspersed. After each metallic layer is deposited, a very thin, intentionally porous insulation layer is laid on top; the insulation layer covers almost all the surface but leaves microscopic pinholes. When the next metallic layer is deposited, metal grows down through those pinholes and welds itself to the layer below, so the entire stack turns into one continuous conductor. The finished structure behaves electrically like a bulk metal bar, yet the embedded porous insulation interrupts eddy currents and tailor skin-depth in ways that ordinary laminates cannot.

It is also possible to form a hybrid material with a heterogeneous or heterogenous mixture of a base material, by forming the base material of the hybrid magnetic material while also depositing the hybrid insulation. The result is particles of hybrid insulation which are interspersed, often randomly, throughout the base material, serving as miniature hybrid insulation layers.

When it comes to layered hybrid materials, it can be stated more formally, that, in at least one embodiment of the present invention a Hybrid Material-denotes a monolithic conductive body formed by the successive deposition of (i) an electrically conductive metallic stratum and (ii) a deliberately porous electrically insulating stratum in such a way that, during deposition of the next metallic stratum, metal penetrates the porosity and metallurgically bonds to the underlying conductor across substantially the entire interfacial area. The resulting body behaves electrically as a single conductor characterised by a unitary skin-depth and a strongly anisotropic (direction-dependent) impedance profile. Because continuity between conductive strata is created in situ through the pores of the insulating stratum, the process can be completed without a subsequent step-such as drilling, laser-ablating, etching, or photo-patterning—to open discrete holes or vias. In fact, any structure that attains interlayer conductivity only by such post-deposition apertures constitutes a laminate and is expressly excluded from this definition.

Further, in at least one embodiment of the present invention, a hybrid insulation layer-designates the specific porous dielectric strata that appear within a hybrid material. In an example case, each layer (a) possesses a bulk resistivity of at least 500 μΩ·cm (e.g., SiO₂, Al₂O₃ or ZrO₂); (b) is 10 nm to 5 μm thick, preferably 30-250 nm when deposited by AP-PECVD or combustion CVD; (c) covers 90-99.99% of the underlying metal while leaving a statistically distributed network of through-voids having individual lateral dimensions<40 μm and an overall open-area fraction of 0.01-10%; and (d) is sufficiently permeable that the underlying metal can act directly as the electrode (or catalyst) for depositing the next metallic stratum without seed activation, drilling or via formation. Once back-filled with metal, the layer becomes mechanically interlocked with adjoining conductors and cannot be peeled away as a discrete film, further distinguishing it from the dense dielectric sheets used in traditional laminates.

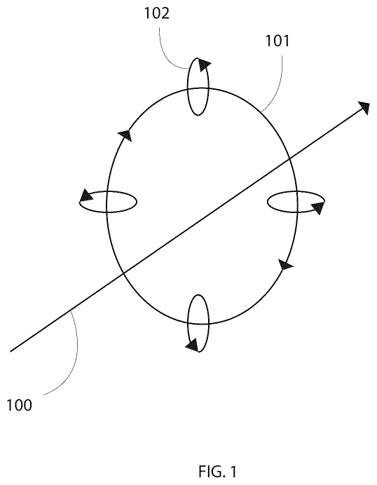

FIG. 1 illustrates the generation of eddy currents in a conventional conductor. A current path 100 carries alternating current, which generates a magnetic flux 101. The magnetic flux 101 induces eddy currents 102 that flow in opposition to the original current in the current path 100.

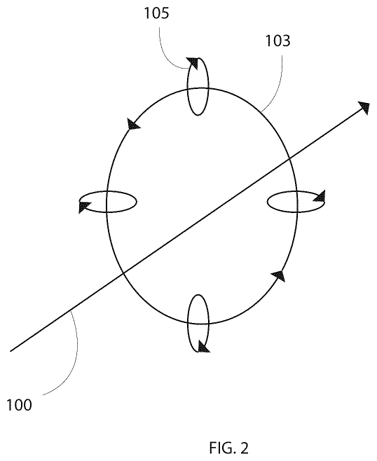

In contrast, FIG. 2 demonstrates the behavior of current and associated magnetic effects in an exemplary embodiment of the hybrid material of the present invention. A current path 100 generates a diamagnetic flux 103, which in turn produces eddy currents 105. The diamagnetic flux 103 flows in an opposite direction compared to the magnetic flux 101 in FIG. 1, resulting in eddy currents 105 that flow in a different direction than the eddy currents 102 in FIG. 1, and these eddy currents reduce each other as does the magnetic flux.

In some cases, the conductive layer may be composed of copper, silver, or a hybrid material itself. The magnetic alloy layer may be operably connected to the conductive layer. In some implementations, the magnetic alloy layer comprises a nickel-iron alloy, a nickel-iron-cobalt alloy, or a hybrid magnetic layer.

The hybrid insulation layer may be operably connected to at least one of the conductive layers or the magnetic alloy layer. In some cases, the hybrid insulation layer comprises a particulate-based insulation material. In some cases, the hybrid insulation layer comprises an interspersed heterogeneous mixture of hybrid insulation particulates within a base material.

A feature of the magnetic alloy layer is its ability to become diamagnetic at high frequencies. In some implementations, the magnetic alloy layer becomes diamagnetic at frequencies above 1 GHz. More specifically, for at least nickel-iron layers, the magnetic alloy layer may become diamagnetic at frequencies between 1 and 20 GHz.

The combination of these layers-conductive, nickel-iron, and hybrid insulation-creates a structure that may effectively reduce skin effect across a wide range of frequencies. The hybrid insulation layer may help mitigate eddy currents at lower frequencies, while the diamagnetic properties of the magnetic alloy layer at higher frequencies may further reduce magnetic flux and associated eddy currents.

The hybrid conductive material of the present disclosure may exhibit different magnetic behaviors depending on the frequency of the current passing through the material. To understand these behaviors, it may be helpful to examine the magnetic interactions between ferromagnetic materials and between ferromagnetic and diamagnetic materials.

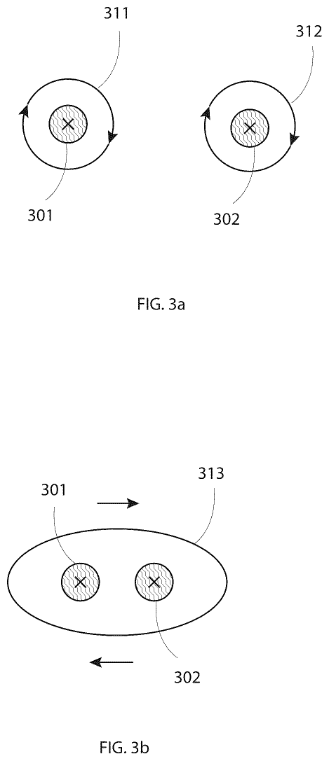

FIG. 3a illustrates the magnetic flux patterns generated by two separate ferromagnetic materials. A first ferromagnetic material 301 generates a first magnetic flux 311, while a second ferromagnetic material 302 generates a second magnetic flux 312. In FIG. 3b, when the first ferromagnetic material 301 and the second ferromagnetic material 302 are brought into proximity, the first magnetic flux 311 and the second magnetic flux 312 combine to form a combined magnetic flux 313. The combined magnetic flux 313 may be stronger and extend over a larger area than the individual magnetic flux patterns.

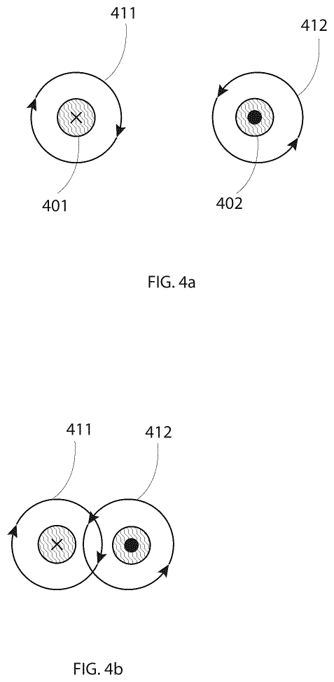

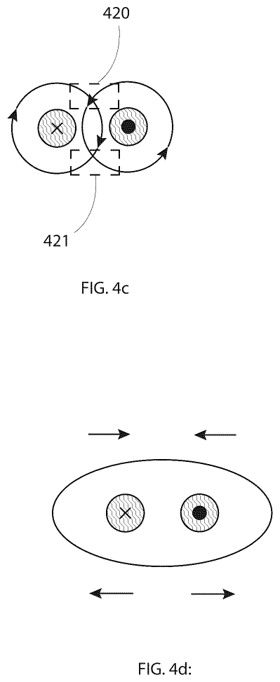

In contrast, FIG. 4a depicts the magnetic flux patterns generated by a ferromagnetic material 401 and a diamagnetic material 402. The ferromagnetic material 401 generates a ferromagnetic flux 411, while the diamagnetic material 402 generates a diamagnetic flux 412. When these materials are brought into proximity, as shown in FIG. 4b, the ferromagnetic flux 411 and the diamagnetic flux 412 oppose each other. It is worth noting that, for example, copper and nickel-iron do not generate the same magnetic field at the same frequency; therefore, these two opposing magnetic fields will not cancel. Instead, the result will be a magnetic field that is reduced.

FIG. 4c illustrates the regions where the opposing magnetic fields interact. An upper magnetic opposition region 420 and a lower magnetic opposition region 421 form where the ferromagnetic flux 411 and the diamagnetic flux 412 meet. In these regions, the opposing magnetic fields may result in a reduction of the overall magnetic field strength. These fields would not combine if perfectly matched, and as such, the loop shown in FIG. 4d would not exist.

The behavior of the magnetic alloy layer in the hybrid conductive material may vary depending on the frequency of the current passing through it. As stated above, in some cases, the magnetic alloy layer may become diamagnetic at frequencies above 1 GHz. More specifically, a nickel-iron alloy layer may become diamagnetic at frequencies between 1-20 GHz.

At lower frequencies, the magnetic alloy layer may behave as a ferromagnetic material, similar to the interaction shown in FIG. 3b. However, as the frequency increases and exceeds 1 GHz, the magnetic alloy layer may transition to behave more like a diamagnetic material, as illustrated in FIG. 4b and FIG. 4c.

This transition in magnetic behavior may contribute to the reduction of skin effect in the hybrid conductive material at higher frequencies. The opposing magnetic fields between the now-diamagnetic magnetic alloy layer and the conductive layer may result in a reduction of the overall magnetic field strength, potentially leading to a decrease in eddy current formation and an increase in the effective skin depth of the material.

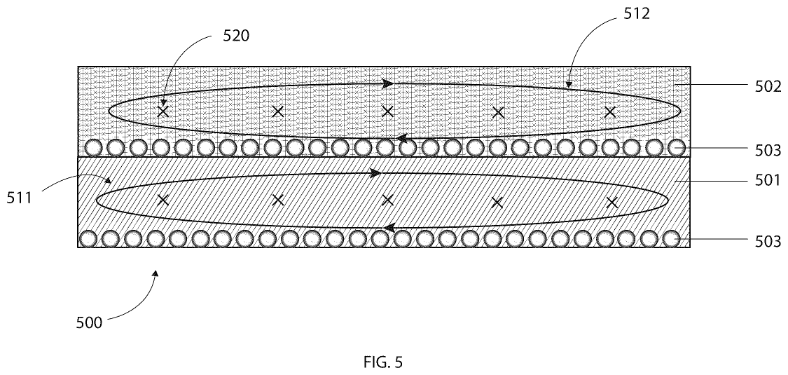

The hybrid conductive material may comprise a layer stack 500 with multiple layers arranged in a specific configuration. FIG. 5 illustrates an exemplary layer stack 500 that includes a conductive layer 501, a magnetic alloy layer 502, and hybrid insulation layers 503. It is worth noting that cobalt may be added to the magnetic alloy layer to form a cobalt-nickel-iron alloy. It is also worth noting that the copper layer and the magnetic alloy layer may be a hybrid conductive layer or a hybrid magnetic layer, respectively.

In some cases, the layer stack 500 may include a first conductive layer, which may be the conductive layer 501. A hybrid insulation layer 503 may be operably connected to the conductive layer 501. In some implementations, a magnetic alloy layer 502 may be operably connected to the hybrid insulation layer 503. The layer stack 500 may further comprise an additional conductive layer, which may be operably connected to the hybrid insulation layer 503. In some cases, multiple hybrid insulation layers may be used and may be used at various intervals.

The arrangement of layers in general may vary. In some cases, the magnetic alloy layer 502 may be positioned between the conductive layer 501 and the hybrid insulation layer 503. The hybrid insulation layer 503 may be positioned between the magnetic alloy layer 502 and the additional conductive layer.

The thickness of the layers in the layer stack 500 may vary. In some implementations, the conductive layer 501 may have a thickness of 250 nm, while the magnetic alloy layer 502 may have a thickness of 100 nm.

FIG. 5 also illustrates the magnetic field interactions within the layer stack 500. Current paths 520 may flow through both the conductive layer 501 and the magnetic alloy layer 502. The current flow may generate magnetic fields in each conductive layer, but with opposing orientations.

In some cases, a magnetic field 511 may flow in a clockwise direction within the conductive layer 501. Conversely, a magnetic field 512 may flow in a counterclockwise direction within the magnetic alloy layer 502. The hybrid insulation layers 503 may be positioned at the interfaces between the conductive layer 501 and the magnetic alloy layer 502.

The hybrid insulation layer significantly increases the resistance between layers across frequencies. Because flux and eddy currents are intimately tied together, this also reduces the flux. The result is effectively a separation between the layers that further reduces the eddy current generated. So, at high frequencies, the magnetic alloy has directly reduced the strength of the flux, while the hybrid insulation has directly reduced the strength of the eddy currents. In some cases, a potential ratio of conductive material to magnetic material, for example, copper to nickel-iron, would be 250 nm to 100 nm. It is worth noting that at lower frequencies, the hybrid material is strong enough to effectively eliminate eddy currents.

In some implementations, the layer stack 500 may include conductive pillars at the sides. These conductive pillars may help the current turn into the path of least resistance, potentially improving the overall conductivity of the hybrid conductive material.

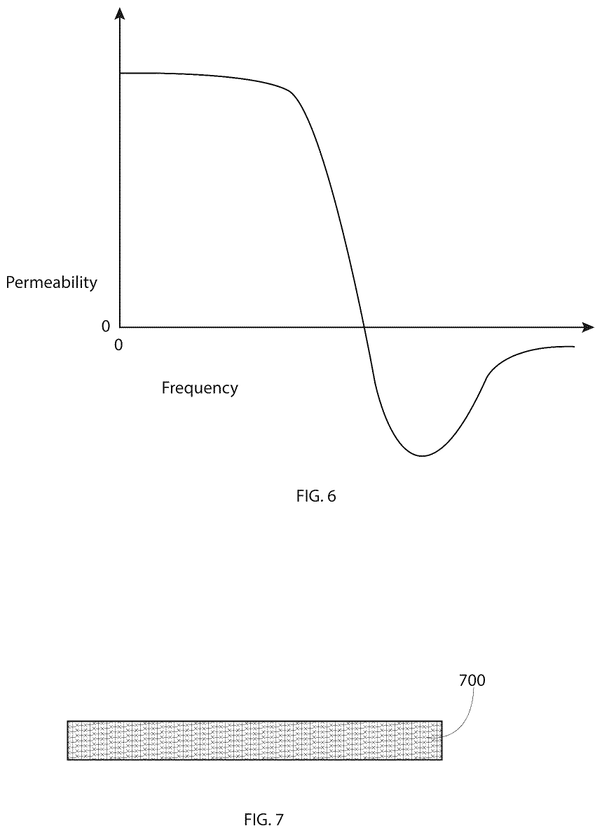

FIG. 6 depicts a graph showing the relationship between permeability and frequency for the magnetic alloy layer 502. The graph illustrates how the magnetic properties of the magnetic alloy layer 502 may change with frequency, potentially affecting the magnetic field interactions within the layer stack 500 at different operating frequencies.

The formation of the layer stack may begin with preparing an initial conductive layer 700. FIG. 7 illustrates a conductive layer 700, which in some cases may comprise copper or a hybrid copper material. The conductive layer 700 may serve as the foundation for subsequent layer deposition.

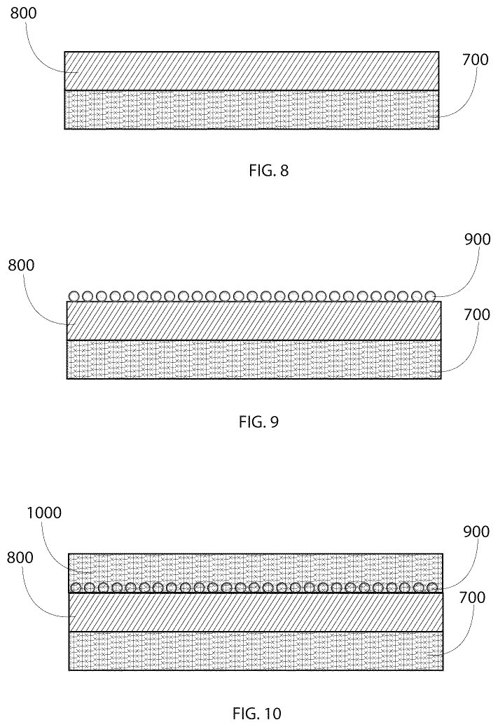

In some implementations, a first layer may be formed on a surface of the conductive layer 700. FIG. 8 depicts a magnetic alloy layer 800 formed on the conductive layer 700. The magnetic alloy layer 800 may be deposited using various methods. In some cases, the magnetic alloy layer 800 may be formed using electroless plating. In other cases, the magnetic alloy layer 800 may be formed using metal ink plating. In other cases, by electroplating.

FIG. 9 shows the addition of a hybrid insulation layer 900 on top of the magnetic alloy layer 800. The hybrid insulation layer 900 may be formed using different techniques. In some implementations, the hybrid insulation layer 900 may be a printed insulation layer. In other cases, the hybrid insulation layer 900 may be formed using combustion chemical vapor deposition.

The layer stack may be completed with the deposition of an additional conductive layer 1000, as illustrated in FIG. 10. The additional conductive layer 1000 may be deposited on a surface of the hybrid insulation layer 900.

In some cases, the order of layer deposition may be altered. For example, the hybrid insulation layer 900 may be formed directly on the conductive layer 700, followed by the magnetic alloy layer 800. The specific arrangement of layers may depend on the desired properties of the final layer stack. In other cases, a hybrid insulation layer may be placed at the junction of each layer.

The formation process described above may result in a basic layer stack comprising the conductive layer 700, the magnetic alloy layer 800, the hybrid insulation layer 900, and the additional conductive layer 1000. This layer stack may provide a foundation for more complex structures with multiple repetitions of these layers.

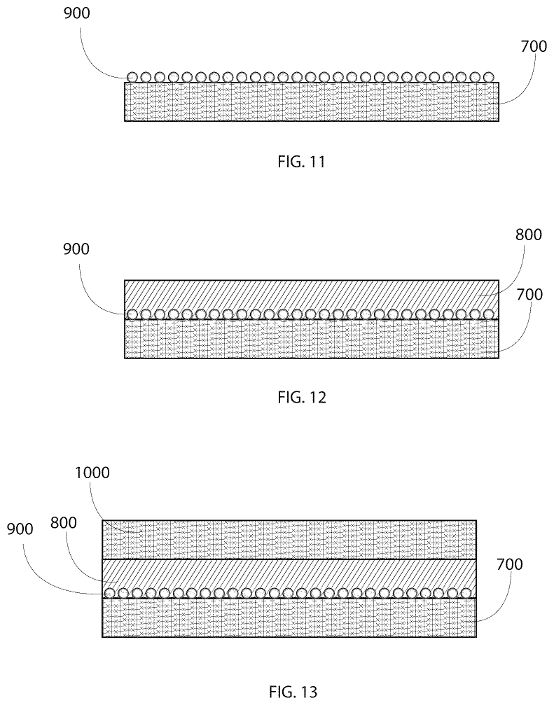

As noted above, the hybrid conductive material may be configured in various layer stack arrangements to optimize performance for specific applications. FIG. 11 illustrates an alternative configuration where a hybrid insulation layer 900 is formed directly on the conductive layer 700. This arrangement may provide enhanced insulation between conductive layers in some cases.

FIG. 12 depicts a further modification to the layer stack, where a magnetic alloy layer 800 is formed on top of the hybrid insulation layer 900. This configuration may allow for better control of magnetic field interactions between the conductive layer 700 and the magnetic alloy layer 800.

In some implementations, an additional conductive layer 1000 may be added to complete the layer stack, as shown in FIG. 13. The additional conductive layer 1000 may be formed on the magnetic alloy layer 800, creating a repeating pattern of conductive, insulating, and magnetic layers.

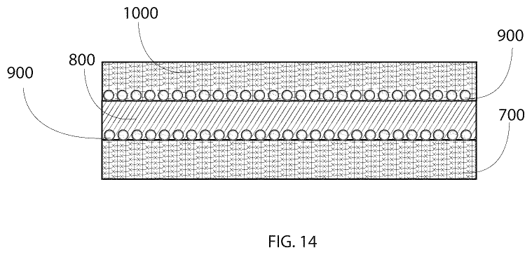

FIG. 14 demonstrates a more complex layer stack configuration. In this arrangement, hybrid insulation layers 900 are positioned between each conductive and magnetic layer. The layer stack includes the conductive layer 700, followed by a hybrid insulation layer 900, a magnetic alloy layer 800, another hybrid insulation layer 900, and an additional conductive layer 1000. This configuration may provide enhanced insulation and magnetic field control throughout the entire stack.

In some cases, the layer stack may comprise a large number of repeating layers. The multi-layer stack may include at least 1000 layers in some implementations. This high number of layers may allow for fine-tuning of the hybrid conductive material's properties and performance across a wide range of frequencies.

The layer stack may also incorporate additional materials to further enhance its performance. In some implementations, a cobalt-magnetic alloy layer may be operably connected between the hybrid insulation layer 900 and the magnetic alloy layer 800. This additional layer may modify the magnetic properties of the stack, potentially improving its performance in specific frequency ranges.

The process of forming these complex layer stacks may involve repeating the steps of forming the first layer, forming the second layer, and depositing the additional conductive layer. This repetition may create a multi-layer stack with the desired number of layers and configuration.

In some cases, the layer stack configurations described may be used to replace traditional Litz wires in various applications. The hybrid conductive material may offer improved performance, particularly at high frequencies, while potentially reducing manufacturing complexity and cost compared to Litz wires.

The interaction between the magnetic alloy layer and the hybrid insulation layer may significantly affect the properties and performance of the hybrid conductive material. In some cases, the hybrid insulation layer may comprise a particulate-based hybrid insulation material. The magnetic alloy layer may interact with the hybrid insulation layer in various ways, including filling voids, pinching off voids, and covering voids.

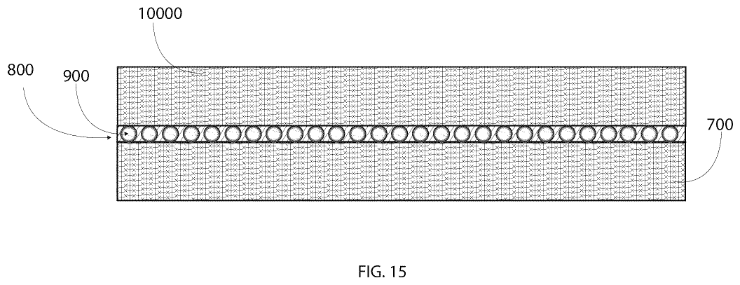

FIG. 15 illustrates a layer stack 10000 where the magnetic alloy layer 800 fills voids in the hybrid insulation layer 900. In some cases, the magnetic alloy layer 800 may occupy the same vertical plane as the hybrid insulation layer 900. This arrangement may result in an integrated layer where both materials exist at the same vertical level within the layer stack 10000. The magnetic layers may be expanded in some cases, as may be particularly powerful when the magnetic material is formed simultaneously with a hybrid insulation layer (forming the heterogenous mixture as described above).

In some implementations, the magnetic alloy layer 800 may fill voids in the hybrid insulation layer 900 without extending more than 1 nanometer above a surface of the hybrid insulation layer 900. This configuration may provide a smooth interface between the layers while maintaining the insulating properties of the hybrid insulation layer 900.

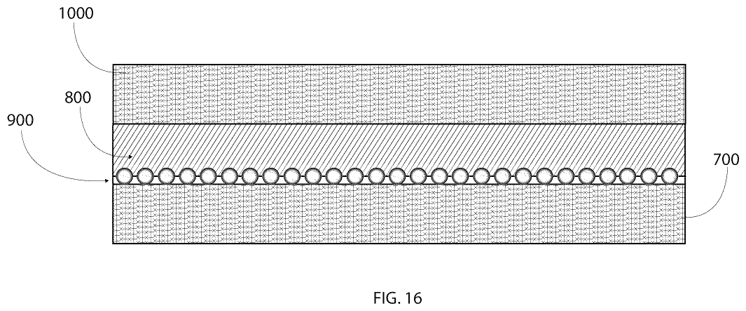

FIG. 16 demonstrates an arrangement where the magnetic alloy layer 800 pinches off voids in the hybrid insulation layer 900. In this configuration, the magnetic alloy layer 800 may extend partially into the voids of the hybrid insulation layer 900, creating a pinched-off effect. The magnetic alloy layer 800 may come down about halfway into the voids of the hybrid insulation layer 900, potentially altering the electrical and magnetic properties of the interface between the layers.

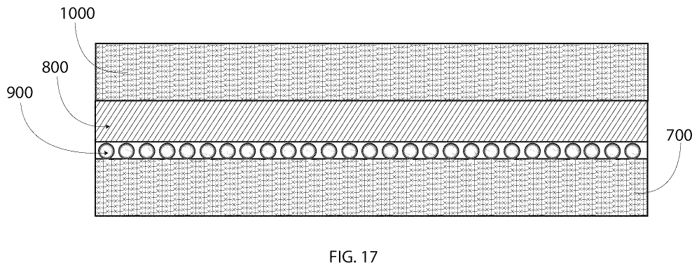

FIG. 17 shows a configuration where the magnetic alloy layer 800 covers voids in the hybrid insulation layer 900 without filling them. In this arrangement, the magnetic alloy layer 800 may form a covering over the voids of the hybrid insulation layer 900, potentially creating small air pockets or gaps between the layers. This configuration may affect the overall conductivity and magnetic properties of the layer stack. These interactions, of pinching and covering, may be performed on multiple hybrid insulation layers in some cases.

The interaction between the magnetic alloy layer 800 and the hybrid insulation layer 900 may influence the electrical and magnetic characteristics of the hybrid conductive material. In some cases, filling the voids may increase the contact area between the layers, potentially enhancing conductivity. Pinching off or covering the voids may create small insulating regions within the layer stack, which may affect the material's response to high-frequency currents.

The specific interaction between the magnetic alloy layer 800 and the hybrid insulation layer 900 may be controlled through various deposition techniques. In some implementations, electroless plating may be used to achieve a pinched-off configuration. Metal ink plating may be employed to create a covering effect over the voids without significant penetration into the hybrid insulation layer 900.

The choice of interaction method between the magnetic alloy layer 800 and the hybrid insulation layer 900 may depend on the desired properties of the hybrid conductive material. Different configurations may be selected to optimize performance for specific frequency ranges or applications.

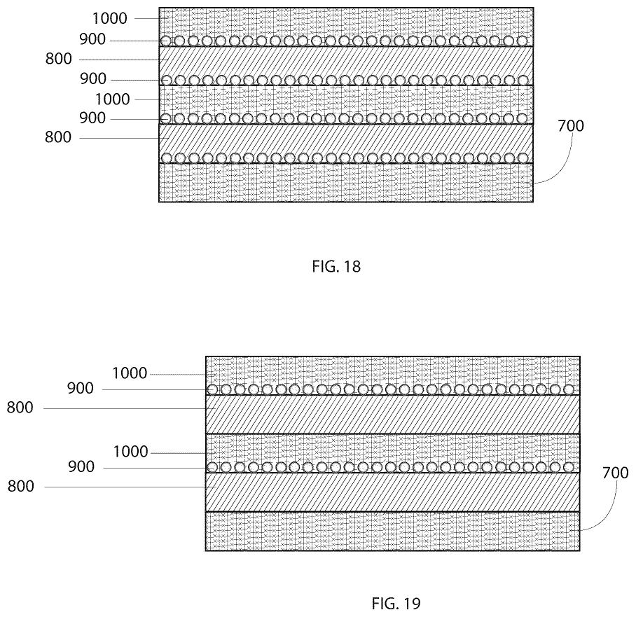

The hybrid conductive material may be configured in various repeating layer patterns to optimize performance for specific applications. FIG. 18 illustrates a layer stack comprising multiple alternating layers. The layer stack includes an initial conductive layer 700 at the base. A hybrid insulation layer 900 is formed on the surface of the conductive layer 700. A magnetic alloy layer 800 is positioned on top of the hybrid insulation layer 900. An additional conductive layer 1000 is formed on the magnetic alloy layer 800. This pattern of layers repeats, with another hybrid insulation layer 900 deposited on the additional conductive layer 1000, followed by another magnetic alloy layer 800, and topped with a final additional conductive layer 1000. Again, in some cases, these materials themselves may be replaced with hybrid conductive or magnetic materials, respectively. It is worth noting that multiple hybrid insulation layers may be used and that these layers may extend into the layers themselves.

In some cases, the repeating pattern shown in FIG. 18 may be repeated multiple times to create a multi-layer stack. The number of repetitions may vary depending on the desired properties of the hybrid conductive material. In some implementations, the multi-layer stack may comprise at least 1000 layers.

FIG. 19 demonstrates an alternative repeating layer pattern. The layer stack begins with an initial conductive layer 700. A magnetic alloy layer 800 is formed directly on the initial conductive layer 700, followed by a hybrid insulation layer 900. An additional conductive layer 1000 is positioned on top of the hybrid insulation layer 900. This sequence of layers-magnetic alloy layer 800, hybrid insulation layer 900, and additional conductive layer 1000-repeats in the structure shown.

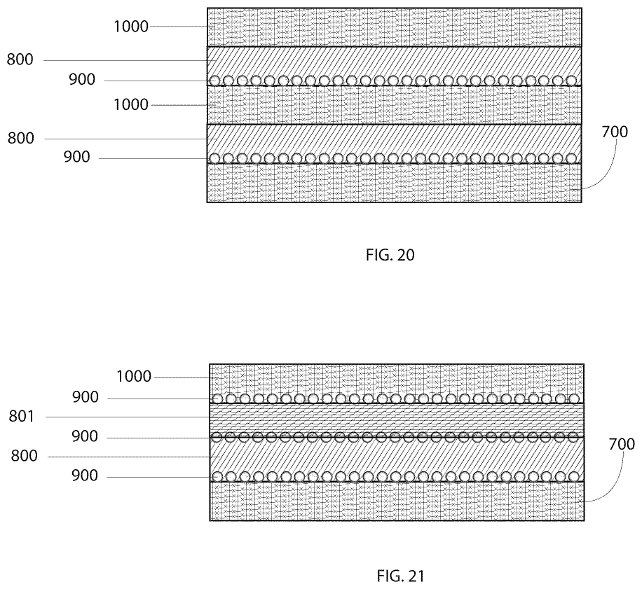

FIG. 20 presents yet another variation of the repeating layer pattern. In this configuration, the layer stack starts with an initial conductive layer 700. A hybrid insulation layer 900 is formed on the surface of the conductive layer 700. A magnetic alloy layer 800 is positioned on top of the hybrid insulation layer 900. An additional conductive layer 1000 is formed on the magnetic alloy layer 800. This pattern of layers repeats, creating a structure with alternating conductive, insulating, and magnetic layers.

The hybrid conductive material may incorporate additional materials to further enhance performance. FIG. 21 illustrates an advanced configuration that includes a cobalt magnetic alloy layer 801. The layer stack begins with an initial conductive layer 700. A hybrid insulation layer 900 is positioned directly above the initial conductive layer 700. A cobalt magnetic alloy layer 801 is formed on top of the hybrid insulation layer 900. Another hybrid insulation layer 900 is positioned above the cobalt magnetic alloy layer 801. A magnetic alloy layer 800 follows, positioned on top of the second hybrid insulation layer 900. An additional hybrid insulation layer 900 is placed above the magnetic alloy layer 800. The stack is completed with an additional conductive layer 1000 at the top.

In some cases, the incorporation of a cobalt magnetic alloy layer 801 may modify the magnetic properties of the layer stack. The cobalt magnetic alloy layer 801 may provide additional control over the magnetic behavior of the hybrid conductive material at different frequencies.

The specific arrangement and composition of layers in the hybrid conductive material may be tailored to meet the requirements of various applications. In some implementations, different layer patterns may be combined within a single layer stack to optimize performance across a wide range of frequencies. For example, in alternate embodiments, these layers may also be a hybrid conductor, for example, hybrid copper; a hybrid magnetic material, for example, hybrid nickel-iron; and in general, a conductive material and a diamagnetic or anti-permeable material.

The repeating layer patterns and advanced configurations described may allow for fine-tuning of the hybrid conductive material's properties. In some cases, these complex layer stacks may provide enhanced control over eddy current formation and magnetic flux distribution throughout the material.

A number of implementations have been described. Nevertheless, it will be understood that various modifications may be made without departing from the spirit and scope of the disclosure. Accordingly, other implementations are within the scope of the following claims.

1. A hybrid conductive material, comprising:
a conductive layer;
a magnetic alloy layer operably connected to the conductive layer; and
a hybrid insulation layer operably connected to at least one of the conductive layer or the magnetic alloy layer.

2. The hybrid conductive material of claim 1, wherein the magnetic alloy layer is a cobalt-nickel-iron cobalt alloy.

3. The hybrid conductive material of claim 1, wherein the magnetic alloy layer comprises a nickel-iron alloy selected from the group consisting of 80:20, 36:64, and 40:60 nickel to iron ratios.

4. The hybrid conductive material of claim 1, wherein the hybrid insulation layer comprises a particulate-based hybrid insulation material.

5. The hybrid conductive material of claim 1, wherein at least one of the conductive material or the magnetic material is a hybrid material.

6. The hybrid conductive material of claim 1, further comprising an additional conductive layer operably connected to the hybrid insulation layer.

7. The hybrid conductive material of claim 6, wherein the magnetic alloy layer is positioned between the conductive layer and the hybrid insulation layer, and the hybrid insulation layer is positioned between the magnetic alloy layer and the additional conductive layer.

8. The hybrid conductive material of claim 7, wherein the magnetic alloy layer fills voids in the hybrid insulation layer.

9. A method of forming a hybrid conductive material, comprising:
preparing an initial conductive layer;
forming a first layer of either hybrid insulation or magnetic alloy on a surface of the initial conductive layer;
forming a second layer of either hybrid insulation or magnetic alloy, whichever material differs from the first layer, on a surface of the first layer; and
depositing an additional conductive layer on a surface of the second layer.

10. The method of claim 9, wherein the initial conductive layer comprises copper.

11. The method of claim 9, wherein the magnetic alloy layer comprises a nickel-iron alloy selected from the group consisting of 80:20, 36:64, and 40:60 nickel to iron ratios.

12. The method of claim 9, wherein the hybrid insulation layer comprises a particulate-based insulation material.

13. The method of claim 9, further comprising repeating the steps of forming the first layer, forming the second layer, and depositing the additional conductive layer to create a multi-layer stack.

14. The method of claim 9, wherein at least one of the conductive material or magnetic material is a hybrid material.

15. The method of claim 14, wherein the multi-layer stack comprises at least 1000 layers.

16. The method of claim 15, wherein the magnetic alloy layer fills voids in the hybrid insulation layer without extending more than 1 nanometer above a surface of the hybrid insulation layer.

17. A layered conductive structure, comprising:
a first conductive layer;
a hybrid insulation layer operably connected to the first conductive layer;
a magnetic alloy layer operably connected to the hybrid insulation layer; and
a second conductive layer operably connected to the magnetic alloy layer,
wherein the magnetic alloy layer becomes diamagnetic at frequencies above 1 GHz.

18. The layered conductive structure of claim 17, wherein the magnetic alloy layer comprises a nickel-iron alloy selected from the group consisting of 80:20, 36:64, and 40:60 nickel to iron ratios.

19. The layered conductive structure of claim 17, wherein the hybrid insulation layer comprises a particulate-based insulation material.

20. The layered conductive structure of claim 19, wherein the magnetic alloy layer fills voids in the particulate-based insulation material of the hybrid insulation layer.

21. The layered conductive structure of claim 20, wherein the magnetic alloy layer does not extend more than 1 nanometer above a surface of the hybrid insulation layer.

22. The layered conductive structure of claim 17, further comprising cobalt in the magnetic alloy layer.

23. The layered conductive structure of claim 17, wherein at least one of the conductive material or magnetic material is a hybrid material.
